(19) United States
(12) Patent Application Publication
(10) Pub. No.: US 2008/0109508 A1
(43) Pub. Date: May 8, 2008

(54) SYSTEM HAVING A CARRY LOOK-AHEAD (CLA) ADDER

(76) Inventors: Prashant U. Kenkare, Austin, TX (US); Jogendra C. Sarker, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/550,835

(22) Filed: Oct. 19, 2006

(51) Int. Cl. G06F 7/50

(52) U.S. Cl. 708/710

(57) ABSTRACT

In a system having stored operands in various locations, addition is performed without having to store the operands in preparation for an add operation. Bitwise propagate and generate terms are efficiently created to speed up additions in the system. Combinational logic circuitry has a plurality of inputs and provides a first operand and a second operand during a first phase of a cycle of a clock signal. A carry look-ahead adder (CLA) has first and second inputs directly connected to the combinational logic circuitry for respectively receiving the first operand and the second operand during the first phase of the cycle of the clock signal and creates generate bits and propagate bits prior to beginning of a second phase of the cycle of the clock signal. The adder uses the generate bits and propagate bits to provide a sum of the first operand and the second operand.

### FIELD OF THE INVENTION

This invention relates generally to a system having a carry look ahead adder.

### RELATED ART

Carry look-ahead (CLA) adders are used in many data processing systems. An n-bit CLA adder can add two n-bit operands and provide a sum of the two operands through the use of propagate and generate terms. The speed of adders within a data processing system can affect operation speed of the data processing system itself. Therefore, it is desirable to improve the speed of adders, such as CLA adders, in order to improve performance of the data processing system.

### BRIEF DESCRIPTION OF THE DRAWINGS

The present invention is illustrated by way of example and is not limited by the accompanying figures, in which like references indicate similar elements.

FIG. 1 illustrates, in partial schematic and partial block diagram form, a system including a CLA adder in accordance with one embodiment of the present invention.

FIG. 2 illustrates, in partial schematic and partial block diagram form, the CLA adder of FIG. 1 in accordance with one embodiment of the present invention.

FIG. 3 illustrates a timing diagram illustrating the timing of various signals present in FIGS. 1 and 2, in accordance with one embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE DRAWINGS

An (n+1)-bit CLA adder provides a sum of two (n+1)-bit operands, a(0:n) and b(0:n), through the use of fast carry signals created by the Carry look-ahead tree. The operation of conventional CLA adders is known in the art. The basic concept is the use of propagate and generate terms which contribute towards determining the carry signals. In the most common implementation, the propagate and generate terms are initially determined for each single-bit pair of input operands that are to be added. This determination of propagate and generate terms occurs in parallel for all the operand bit pairs. Additional stages of logic are used to subsequently take these single-bit propagate and generate terms to create multi-bit propagate and generate signals corresponding to multiple bit pairs of input operands. Again, this operation occurs in parallel. Hence, a carry look-ahead tree results in the creation of several propagate and generate signals, each of which represents groups containing varying numbers of bit pairs of input operands. Each propagate and generate signal can be either asserted or deasserted. The significance of an asserted generate signal is that it represents the creation of a carry within that group. Similarly, an asserted propagate signal indicates that any carry entering the group will be allowed to propagate out of the group. It is thus seen that propagate and generate terms contribute towards determining the carry value creation and propagation along a carry tree which represents addition of two (n+1)-bit operands.

In systems using conventional CLA adders, each bit of operands a and b is stored in a corresponding latch, where these latched values of a and b are used in the CLA adder to create propagate and generate terms used in providing the final sum. However, in one embodiment of a system using a modified CLA adder as will be described herein, operands a and b are not individually latched. Instead, logic combinations of a and b, corresponding to a propagate term and a generate term, are latched within the modified CLA. That is, as will be described in more detail below, each bit of operands a and b is provided directly from combinational logic circuitry within the system, without being stored, as inputs to logic gates in a first stage of the modified CLA adder whose outputs are latched. These latched outputs correspond to a generate term, which, in one embodiment, is equivalent to the logical expression “aᵢ·bᵢ” and a propagate term, which, in one embodiment, is equivalent to the logical expression “aᵢ+bᵢ,” where i corresponds to a particular bit location within operands a and b. In a first stage of the modified CLA adder to be described herein, a propagate term and a generate term is generated for each of the n+1 bits of operands a(0:n) and b(0:n).

Note that in alternate embodiments, each of the generate terms and propagate terms can refer to any logical expression or combination of aᵢ and bᵢ. For example, in one alternate embodiment, the generate term may be equivalent to the logical expression “a_{i—}bar·b_{i—}bar” (where the “bar” indicates the negative of the corresponding signal). Alternatively, other expressions may be used to define each of the generate and propagate terms. However, for ease of explanation herein, it will be assumed that the generate term corresponds to “aᵢ·bᵢ” and the propagate term to “aᵢ+bᵢ.”

As used herein, the term “bus” is used to refer to a plurality of signals or conductors which may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

The terms “assert” or “set” and “negate” (or “deassert” or “clear”) are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Therefore, each signal described herein may be designed as positive or negative logic, where negative logic can be indicated by a bar over the signal name, the term “bar” following the signal name, or an asterix (*) following the name. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Parentheses are used to indicate the conductors of a bus or the bit locations of a value. For example, “bus 60 (0:7)” or “conductors (0:7) of bus 60” indicates the eight lower order conductors of bus 60, and “address bits (0:7)” or “address (0:7)” indicates the eight lower order bits of an address value. Also, as used in the descriptions herein, note that bit location 0 corresponds to the least significant bit; however, in alternate embodiments, bit location 0 may correspond to the most significant bit.

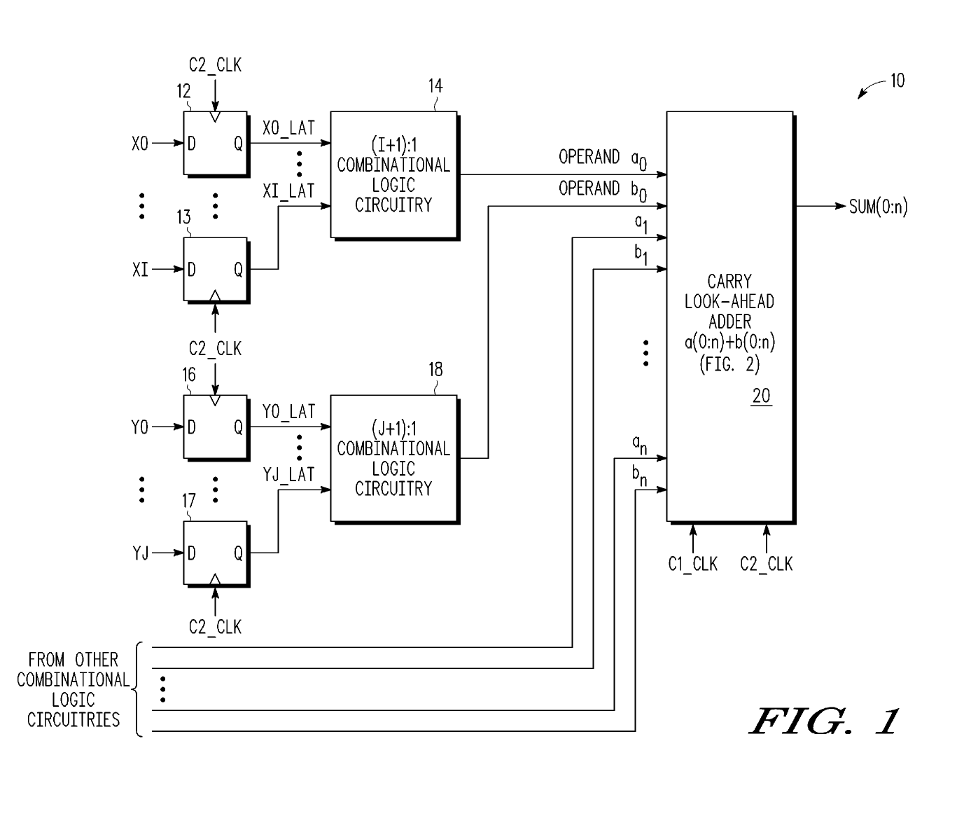

FIG. 1 illustrates a system 10 including a CLA adder 20 in accordance with one embodiment of the present invention. For example, system 10 may be a portion of a data processing system which is located on one or more integrated circuits. For example, CLA adders may be used in a variety of data processing systems, such as in microprocessors, microcontrollers, digital signal processors, peripherals, etc, or in any other circuitry. Also, note that a data processing system may include any number of CLA adders, as needed. System 10 includes a plurality of flip flops, each receiving an input, such as X0, and providing a latched output, such as X0_lat. The latched output is updated when C2_CLK is asserted, but remains unchanged while C2_CLK is deasserted. An input to a flip flop can be received from anywhere within system 10. For example, it may be provided by a cone of combinational logic which is coupled to provide the input of the flip flop. The latched output is then provided to combinational logic circuitry which may form a cone of logic for generating an output. For example, referring to system 10, system 10 includes a plurality of D flip flops 12-13 and D flip flops 16-17, where flip flops 12-13 receive inputs X0-XI, respectively, and flip flops 16-17 receive inputs Y0-YJ, respectively. These flip flops can be located anywhere within system 10, and may be located at distances far away from CLA adder 20. The outputs of flip flops 12-13 (X0_lat to XI_lat) are provided to combinational logic circuitry 14 and the outputs of flip flops 16-17 (Y0_lat to YJ_lat) are provided to combinational logic circuitry 18. The output of combinational logic circuitry 14 provides one bit of operand a (corresponding to bit a₀) to CLA adder 20, and the output of combinational logic circuitry 18 provides one bit of operand b (corresponding to bit b₀) to CLA adder 20. Note that I+1 inputs are provided to combinational logic circuitry 14, where I can be any integer value, and J+1 inputs are provided to combinational logic circuitry 18, where J can be any integer value. Therefore, in alternate embodiments, a different number of flip flops, from 0 to any integer value, may provide inputs to each of combinational logic circuitries 14 and 18. Also, each of combinational logic circuitries 14 and 18 provide a signal bit output, a₀ and b₀, respectively. That is, combinational logic circuitry 14 represents an (I+1) bit input to a 1 bit output, i.e. (1+1):1, circuitry, and combinational logic circuitry 18 represents a (J+1) bit input to a 1 bit output, i.e. (J+1):1, circuitry. Note that each of X0_lat to XI_lat and Y0_lat to YJ_lat can be referred to as input signals to corresponding combinational logic circuitry 14 or 18.

Furthermore, note that other flip flops and combinational circuitry would be present in system 10 to provide each bit of operands a and b. That is, each of a₁-aₙ, and b₁-bₙ, is also provided from other combinational logic circuitries within system 10 to CLA adder 20. Therefore, each bit of operands a and b is provided from combinational logic circuitries (i.e. from various cones of logic) to CLA adder 20. As with flip flops 12-13 and 16-17, these flip flops can be located anywhere within system 10, and may be located at distances far away from CLA adder 20. Also, note that the flip flops, such as flip flops 12-13 and 16-17, can be referred to as storage elements and can be implemented using different types of storing or latching elements.

Note that, as used herein, combinational logic refers to logic which does not include storage elements. For example, combinational logic 14 receives the latched outputs of flip flops 12-13 (X0_lat to XI_lat), and provides a₀, but combinational logic 14 does not include storage elements and thus does not store any of the latched outputs of flop flops 12-13, a₀, nor any intermediate values which may be determined within combinational logic 14.

In one embodiment, combinational logic circuitry 14 may be an I+1 to 1 multiplexer which provides one of the latched outputs of flip flops 12-13 as operand a₀. Therefore, note that combinational logic circuitry 14 may simply provide the value of one of X0_lat to XI_lat as operand a₀ without modifying the value, through the use of combinational logic such as a multiplexer. Alternatively, combinational logic circuitry 14 may include any type of logic circuits and any number of logic gates which provide operand a₀ based on a logic combination of the latched outputs of flip flops 12-13. The same examples apply to any of the combinational logic circuitry of system 10.

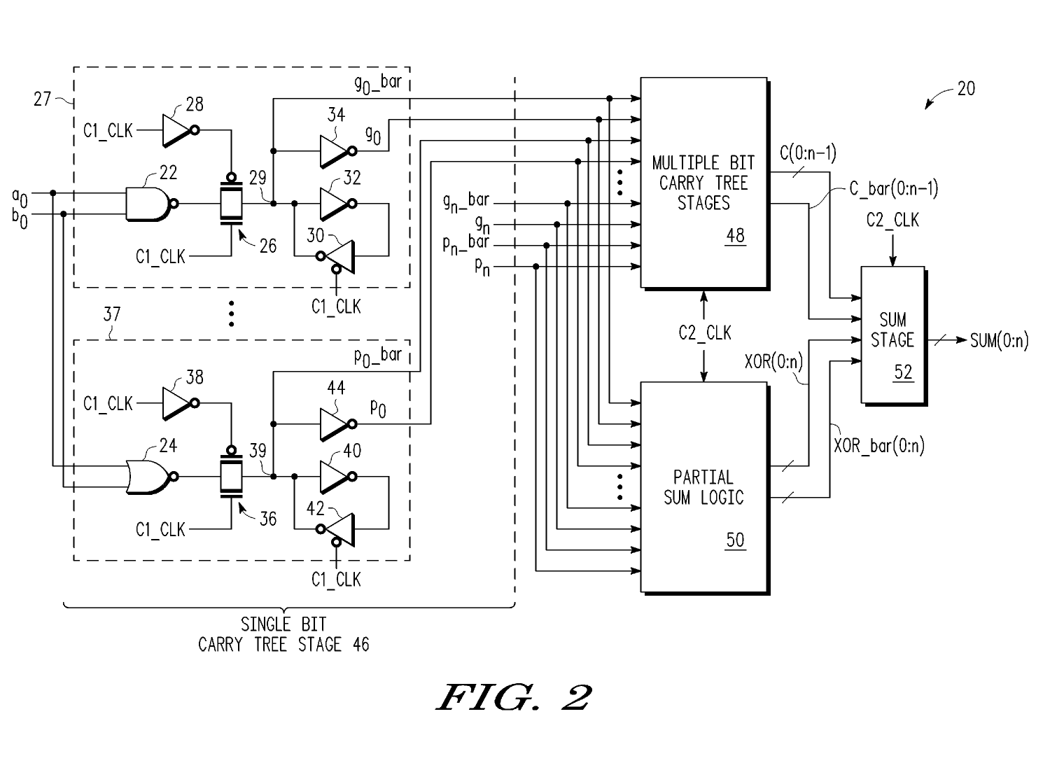

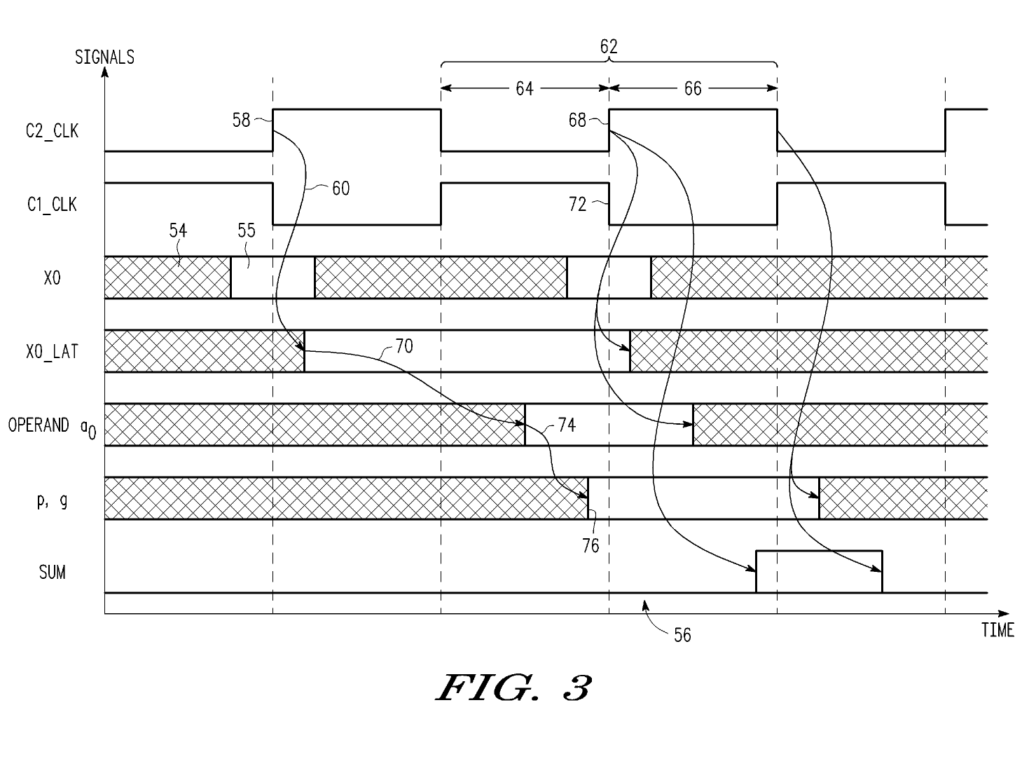

CLA 20 receives operands a(0:n) and b(0:n), computes the arithmetic sum of a and b, and provides sum(0:n), where sum(0:n)=a(0:n)+b(0:n). CLA 20 also receives two clocks, C1_CLK and C2_CLK. Operation of CLA 20 will be described in more detail in reference to FIGS. 2 and 3.

Referring to FIG. 2, CLA 20 includes a single bit carry tree stage 46 having a plurality of latching elements which provide generate and propagate terms for each operand bit location to multiple bit carry tree stages 48 and to XOR and XOR_bar creation 50. For example, a latching element 27 provides generate terms g₀ and g_{0—}bar, corresponding to bit location 0 of operands a and b, and a latching element 37 provides propagate terms p₀ and p_{0—}bar, corresponding to bit location 0 of operands a and b. Single bit carry tree stage 46 includes NAND gate 22, which receives as inputs, bits 0 of operands a and b (i.e. a₀ and b₀) and NOR gate 24, which also receives a₀ and b₀ as inputs. Therefore, note that operands a₀ and b₀ are directly provided from combinational logic circuitries 14 and 18, respectively, as inputs to logic gates 22 and 24 without being stored. That is, the outputs of combinational logic circuitries 14 and 18 are directly connected to the inputs of logic gates 22 and 24 and are not latched or stored in any storage element.

Latching element 27 includes NAND gate 22, a switch 26, and inverters 30, 32, and 34. (Note that inverter 28 may also be considered part of latching element 27.) An output of NAND gate 22 is connected to an input of switch 26 and an output of switch 26 is connected to an input of inverter 32 and an output of inverter 30. An output of inverter 32 is connected to an input of inverter 30. C1_CLK is provided as an input to an inverter 28 whose output is provided to a first control input of switch 26. Switch 26 also receives C1_CLK at a second control input. C1_CLK is also provided to an enable input of inverter 30. The output of switch 26 and inverter 30 is provided as generate term g_{0—}bar and is provided to the input of an inverter 34 which provides as its output generate term g₀. Therefore, g₀ and g_{0—}bar are provided by single bit carry tree stage 46 as the generate terms for single bit location 0. In the illustrated embodiment, g₀ represents the logical value of a₀·b₀ (i.e. of “a₀ AND b₀”). In alternate embodiments, other logic gates may be used in place of NAND 22, and/or the output of inverter 34 may instead provide g_{0—}bar.

Still referring to FIG. 2, latching element 37 includes NOR gate 24, a switch 36, and inverters 40, 42, and 44. (Note that inverter 38 may also be considered part of latching element 37.) An output of NOR gate 24 is connected to an input of switch 36 and an output of switch 36 is connected to an input of inverter 40 and an output of inverter 42. An output of inverter 40 is connected to an input of inverter 42. C1_CLK is provided as an input to an inverter 38 whose output is provided to a first control input of switch 36. Switch 36 also receives C1_CLK at a second control input. C1_CLK is also provided to an enable input of inverter 42. The output of switch 36 and inverter 42 is provided as propagate term P_{0—}bar and is provided to the input of an inverter 44 which provides as its output propagate term p₀. Therefore, p₀ and p_{0—}bar are provided by single bit carry tree stage 46 as the propagate terms for single bit location 0. In the illustrated embodiment, p₀ represents the logical value of a₀+b₀ (i.e. of “a₀ OR b₀”). In alternate embodiments, other logic gates may be used in place of NOR 24, and/or the output of inverter 44 may instead provide p_{0—}bar.

Therefore, single carry tree stage 46 includes a total of n+1 latching elements for latching and providing generate bits g₀, g_{0—}bar through gₙ, g_{n—}bar, respectively, (based on a logical combination of a₀, b₀ to aₙ, bₙ, respectively), and a total of n+1 latching elements for latching and providing propagate bits p₀, p_{0—}bar through pₙ, p_{n—}bar, respectively (based on a logical combination of a₀, b₀ to aₙ, bₙ, respectively). Therefore, a total of 2n+2 latching elements are used within single bit carry tree stage 46, each latching element storing a generate or a propagate bit, each based on a logical combination of a particular bit location of operand a and the same bit location of operand b.

Furthermore, note that a NAND gate and a NOR gate are used in the illustrated embodiment of FIG. 2 to provide the logical combinations of bit locations of operands a and b to generate the generate and propagate terms, respectively. However, in alternate embodiments, different combinational logic circuits can be used in place of the NAND and NOR gates.

In the illustrated embodiment of FIG. 2, each of generate terms g(0:n) and g_bar(0:n) and each of propagate terms p(0:n) and p_bar(0:n) are provided by single bit carry trees stage 46 directly to multiple bit carry tree stages 48 and to partial sum logic 50 which creates true and complement values of the partial sum for each bit pair of operand a and operand b. Multiple bit carry tree stages 48 provides outputs which provide carry information, such as, for example, c(0:n-1) and c bar(0:n-1) to sum stage 52. (The carry information provided by multiple bit carry tree stages 48 may be referred to as carry terms, which may also be or include partial carry terms.) Partial sum logic 50, using the generate and propagate terms for each bit location of operands a and b, provides the partial sums XOR(0:n) and XOR_bar(0:n) to sum stage 52. Sum stage 52, using the carry inputs from multiple bit carry tree stages 48 and the partial sums from partial sum logic 50, calculates and provides the final sum(0:n).

The determination of latched generate terms g(0:n) and g_bar(0:n) and latched propagate terms p(0:n) and p_bar(0:n) occurs in parallel for all the operand bit pairs. This is referred to as the first stage of the carry tree. Additional stages of logic represented by the multiple bit carry tree stages 48 are used to subsequently take these latched single-bit propagate and generate terms to create multi-bit propagate and generate signals corresponding to multiple bit pairs of input operands. As an example, multiple bit carry tree stages 48 includes the second stage of the carry tree which is directly connected to a plurality of latched single-bit generate and propagate terms. This second stage can be used for determining propagate and generate terms corresponding to multiple bit groupings of operand a and operand b. For example, the multiple bit grouping could represent 3 bits of operand a and 3 bits of operand b. The determination of multi-bit propagate and generate terms would then occur in parallel such that a plurality of 3-bit propagate and 3-bit generate terms would be computed. As is known in the art, additional stages of logic in 48 are used to create propagate and generate terms representing even larger number of operand bit pairs. The number of logic stages in 48 depends on the number of bits (n+1) in the adder, and details of the sum stage 52. The implementation shown in FIG. 2 indicates that multiple bit carry tree stages 48 directly produces carry signals that are provided to sum stage 52. However, in an alternate embodiment, multiple bit carry tree stages 48 may instead produce partial carry components which are merged in sum stage 52. As seen in FIG. 2, the sum stage 52 computes SUM(0:n) based on inputs from 48 and 50.

Referring now to partial sum logic 50, the XOR(0:n) outputs represent true values of partial sums of individual bit pairs a₀+b₀ to aₙ+bₙ, and the XOR_bar(0:n) represent complimentary values of partial sums of individual bit pairs a₀+b₀ to aₙ+bₙ. The values of XOR(0:n) and XOR_bar(0:n) are directly computed from latched bit-wise propagate and generate inputs, such as p(0:n), p_bar(0:n), g(0:n), and g_bar(0:n). The creation of latched bit-wise propagate and generate inputs, such as p(0:n), p_bar(0:n), g(0:n), and g_bar(0:n), may provide a benefit over the prior art because this approach may eliminate time delay resulting from explicitly latching operand a and operand b prior to computing the bit-wise propagate and generate terms.

Still referring to FIG. 2, note that the output of logic gate 22 is stored by inverters 32 and 30 (where inverters 32 and 30 may be referred to as clocked latching circuitry). That is, when C1_CLK is high, switch 26 (which, in the illustrated embodiment is represented by a transmission gate, but may alternatively be formed differently, such as by using a single transistor) provides the output of logic gate 22 to the input of inverter 32. However, while C1_CLK is high, note that inverter 30 remains disabled, so as to prevent contention at storage node 29. When C1_CLK goes low, switch 26 is disabled (becomes open) and inverter 30 is enabled such that the value from logic gate 22 is now stored by inverters 32 and 30 and available at storage node 29 (also referred to as latch node 29). Therefore, g₀, which is at the output of inverter 34, corresponds to “a₀·b₀”.

Similarly, the output of logic gate 24 is stored by inverters 42 and 40 (where inverters 42 and 40 may be referred to as clocked latching circuitry). That is, when C1_CLK is high, switch 36 (which, in the illustrated embodiment is represented by a transmission gate, but may alternatively be formed differently, such as by using a single transistor) provides the output of logic gate 24 to the input of inverter 40. However, while C1_CLK is high, note that inverter 42 remains disabled, so as to prevent contention at storage node 39. When C1_CLK goes low, switch 36 is disabled (becomes open) and inverter 42 is enabled such that the value from logic gate 24 is now stored by inverters 42 and 40 and available at storage node 39 (also referred to as latch node 39). Therefore, p₀, which is at the output of inverter 44, corresponds to “a₀+b₀”.

In a conventional CLA adder, each latch in the single bit carry tree stage stores a(0:n) and b(0:n). In this conventional case, inverters are used in place of logic gates 22 and 24, where each inverter receives a particular bit of operand a or b, and the outputs of inverters 34 and 44 would then provide the latched values of the particular bit of operand a or b. The latched outputs in the conventional CLA adder would then be combined to create propagate and generate terms. However, as will be discussed in reference to FIG. 3, the use of latches to latch operands a and b places constraints on timing, while the use of latching elements such as latching elements 27 and 29 (which store generate and propagate terms, respectively, based on logical combinations of a and b) may provide for improved speed.

FIG. 3 illustrates a timing diagram of various signals of FIGS. 1 and 2. Note that in FIG. 3, when hatches or “Xs” are present, the signal is indeterminate, while when the signal is illustrated with both a high line and a low line, the signal is valid, but the actual value (i.e. whether it is a logic high or one, or a logic low or zero) is not identified in the timing diagram. However, when the line of a signal is either low or high, then that signal actually has that value. For example, at time 54, signal X0 is indeterminate and is not valid. However, at time 55, the signal X0 is valid, even though its actual value (a logic high or low) is not being identified in FIG. 3. And, for example, at time 56, the value of signal sum is a logic low (i.e. a logic level zero).

FIG. 3 illustrates two clocks present within system 10 of FIG. 1: C2_CLK and C1_CLK. Note that one clock is just the negative of the other, i.e., they are 180 degrees out of phase with each other. Although ideally the clocks should look as illustrated in FIG. 3, note that in reality, the clocks may not be exactly 180 degrees out of phase. Each clock includes clock cycles, where each clock cycle includes two phases (e.g. a high phase and a low phase). For example, during a full clock cycle of C2_CLK, C2_CLK is either high or low for a first phase and is then either low or high for a second phase such that each full clock cycle includes two phases where the two phases are separated by a clock edge (either a rising or falling edge). Therefore, note that clock cycle 62 of C2_CLK includes a first phase 64 during which the clock is low and a second phase 66 during which the clock is high.

FIG. 3 includes signal X0 which is an input to flip flop 12 of FIG. 1. X0 is valid at the D input of flip flop 12 some time before a rising edge 58 of C2_CLK, such that when C2_CLK goes high, the value of X0 is properly latched into flip flop 12. At some time after rising edge 58 of C2_CLK, the latched X0 value, X0_lat, is available at the Q output of flip flop 12, as illustrated by arrow 60. Note that since X0_lat is provided by a D flip flop, the value of X0_lat is valid for a full clock cycle of C2_CLK, where it again becomes indeterminate at some time after the next rising edge 68 of C2_CLK. Once X0_lat is valid, it propagates through combinational logic circuitry 14, where combinational logic circuitry provides the 0^{th} bit of operand a, i.e. a₀. Therefore, as indicated by arrow 70, the value of a₀ in the embodiment illustrated in FIG. 3 follows from X0_lat becoming valid, where a₀ becomes valid at some time after X0_lat based on the propagation delay through combinational logic 14.

Note that the length of time between X0_lat being valid and a₀ being valid is based on the propagation delay of the slowest latched output of flip flops 12-13 through combinational logic circuitry 14. That is, each of values X0_lat through XI_lat need to be valid and propagated through combinational logic circuitry 14 to provide the 0^{th} bit of operand a, i.e. a₀. For example, if combinational logic circuitry 14 were an I+1 input AND logic gate, then the slowest input to the AND logic gate would determine when a₀ becomes valid. Therefore, the time at which a₀ becomes valid may not depend directly on X0_lat, but could depend on another latched output of flip flops 12-13.

When a₀ is valid, the output of logic gates 22 and 24 become valid. This occurs at some time 76 prior to falling edge 72 of C1_CLK and thus, the outputs of logic gates 22 and 24 (corresponding to p and g terms) can be latched by inverters 32 and 30 and inverters 30 and 42 at falling edge 72 of C1_CLK (at which point switches 26 and 36 are disabled and storage nodes 29 and 39 now provide the values of p and g). Therefore, at some short time after a₀ becomes valid (equivalent to the propagation delay through logical gates 22 and 24), the outputs of logical gate 22 and 24 become valid, as illustrated by arrow 74. The values of p and g (such as, for example, g₀, g_{0—}bar, p₀, and p_{0—}bar) then remain valid for a full phase of C2_CLK (i.e. phase 66 of C2_CLK). With the values of p and g being valid, the output sum becomes valid at some point after rising edge 68, where the timing of sum being valid is based on the propagation delay through multiple bit carry tree stages 48, XOR and XOR_bar creation 50, and sum stage 52 (which are all dynamic logic) starting from the time which p and g are latched, such as by latching elements 27 and 37.

Note that, in the illustrated embodiment, a0 and p and g all become valid within a same phase 64 of C2_CLK (and also of C1_CLK). In this manner, the values of p and g are available at the falling edge 72 of C1_CLK for use by multiple bit carry tree stages 48 and XOR and XOR₁₃ bar creation 50. Note that in conventional CLA adders in which the operands a and b are latched, the latched values of a and b would be valid at a time later than the time at which operand a₀ is valid in FIG. 3. That is, the latched values of a and b would not be valid right after the inputs to combinational logic 14 propagate through combinational logic circuitry 14, as is a₀. For example, once a₀ is valid, at some point later, the latched value of a₀ would become valid. Furthermore, upon rising edge 68 of C2_CLK, the latched value of a₀ would be available for the generation of p and g. However, since the value of a₀ would not be latched until rising edge 68, p and g would not be valid until some time after rising edge 68, during phase 66 rather than during phase 64. Therefore, in one embodiment, the use of latching elements 27 and 37 allow for both a₀ and b₀ to be valid in a same first clock phase (e.g. phase 64 of C2_CLK or C1_CLK) as the propagate and generate terms p and g corresponding to a₀ and b₀. Furthermore, in one embodiment, the sum of operands a and b is valid (e.g. provided) during an immediately following second phase of the clock (e.g. phase 66 of C2_CLK or C1_CLK). Therefore, the use of latching elements 27 and 37 may provide a speed improvement, such as, for example, a speed improvement of approximately 15% to 30%. Also, in the illustrated embodiment, note that since operands a and b are not stored, they are not valid during an entire portion of the second phase (e.g. phase 66 of C2_CLK or C1_CLK).

By now it should be appreciated that there has been provided an improved CLA adder in which logical combinations of a and b are stored in preparation for addition rather than operands a and b themselves. That is, the outputs of the combinational logic circuitry (such as circuitry 14 and 18) provide operands (such as a₀-aₙ and b₀-bₙ) that are to be added by a CLA adder, but these outputs of the combinational logic circuitry are not latched prior to the CLA adder performing the addition of the two operands. Instead, logic combinations, such as those performed by logic gates 22 and 24, of particular bit locations of operands a and b are latched or stored in order to possibly provide the final sum faster than as previously possible by conventional CLA adders.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

It should also be understood that all circuitry described herein may be implemented either in silicon or another semiconductor material or alternatively by software code representation of silicon or another semiconductor material.

Although the invention has been described with respect to specific conductivity types or polarity of potentials, skilled artisans appreciated that conductivity types and polarities of potentials may be reversed.

In one embodiment, system 10 is a portion of a computer system such as a personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) devices.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “plurality”, as used herein, is defined as two or more than two. The term another, as used herein, is defined as at least a second or more.

The term “coupled”, as used herein, is defined as connected, although not necessarily directly, and not necessarily mechanically.

Because the above detailed description is exemplary, when “one embodiment” is described, it is an exemplary embodiment. Accordingly, the use of the word “one” in this context is not intended to indicate that one and only one embodiment may have a described feature. Rather, many other embodiments may, and often do, have the described feature of the exemplary “one embodiment.” Thus, as used above, when the invention is described in the context of one embodiment, that one embodiment is one of many possible embodiments of the invention.

Notwithstanding the above caveat regarding the use of the words “one embodiment” in the detailed description, it will be understood by those within the art that if a specific number of an introduced claim element is intended in the below claims, such an intent will be explicitly recited in the claim, and in the absence of such recitation no such limitation is present or intended. For example, in the claims below, when a claim element is described as having “one” feature, it is intended that the element be limited to one and only one of the feature described.

Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

What is claimed is:

1. A system comprising:
a plurality of storage elements, each of the plurality of storage elements receiving one of a plurality of input signals and providing a latched output signal;
combinational logic circuitry having a plurality of inputs, each input of the plurality of inputs receiving a respective latched output signal, the combinational logic circuitry providing a first operand and a second operand during a first phase of a cycle of a clock signal; and
a carry look-ahead adder having first and second inputs directly connected to the combinational logic circuitry for respectively receiving the first operand and the second operand during the first phase of the cycle of the clock signal and creating generate bits and propagate bits prior to beginning of a second phase of the cycle of the clock signal, the carry look-ahead adder using the generate bits and propagate bits to provide a sum of the first operand and the second operand during an immediately following second phase of the cycle of the clock signal.

2. The system of claim 1 wherein the combinational logic circuitry comprises a multiplexer.

3. The system of claim 1 wherein the carry look-ahead adder further comprises:
a plurality of latching elements forming a first stage of a carry tree, each of the plurality of latching elements forming either a generate term or a propagate term from the first operand and the second operand;
a second stage of the carry tree directly connected to a plurality of generate terms and a plurality of propagate terms, the second stage of the carry tree being coupled to one or more stages of the carry tree for carry computation; and
second combinational logic circuitry connected to the plurality of generate terms and the plurality of propagate terms for partial sum calculation.

4. The system of claim 3 wherein the carry look-ahead adder further comprises:
a sum stage coupled to the one or more stages of the carry tree and to the second combinational logic circuitry for respectively receiving the carry terms and the partial sum terms and providing the sum.

5. The system of claim 3 wherein the plurality of latching elements further comprise:
logic gates for receiving the first operand and the second operand and providing the generate terms and propagate terms without previously storing the first operand and the second operand;
a plurality of switches controlled by the clock signal, each of the plurality of switches connected to a predetermined one of the generate terms or propagate terms; and
a plurality of storage cells, each of the plurality of storage cells connected to a predetermined one of the plurality of switches for storing a respective one of the generate terms or propagate terms.

6. The system of claim 1 wherein the carry look-ahead adder creates generate and propagate bits during the first phase of the cycle of the clock signal without storing the first operand or the second operand.

7. The system of claim 1 wherein the first operand and the second operand are not valid values during an entire portion of the second phase of the cycle of the clock signal.

8. A method comprising:
receiving a plurality of input signals and latching the plurality of input signals;
providing a first operand and a second operand by using the plurality of input signals, the first operand and the second operand being provided during a first phase of a cycle of a clock signal and not being stored;
logically processing the first operand and the second operand with a first combinational logic circuit during the first phase of the cycle of the clock signal to create generate bits and propagate bits prior to a beginning of a second phase of the cycle of the clock signal; and
storing the generate bits and propagate bits for use in an add operation.

9. The method of claim 8 further comprising:
directly connecting the generate bits to respective inputs of a carry tree circuit to provide bits with carry information;
directly connecting the propagate bits to respective inputs of a second combinational logic circuit to provide partial sum bits; and
processing the bits with carry information and partial sum bits to provide a sum of the first operand and the second operand.

10. The method of claim 8 further comprising:
providing the first operand and the second operand during a portion of a second phase of the cycle of the clock signal, the first operand and the second operand not being valid values during an entire portion of the second phase of the cycle of the clock signal.

11. The method of claim 8 further comprising:
providing the first operand and the second operand by using a second combinational logic circuit; and
directly connecting the first combinational logic circuit to the second combinational logic circuit to receive the first operand and the second operand without storage of the first operand and the second operand.

12. The method of claim 8 further comprising:
storing the generate bits and propagate bits during the first phase of the cycle of the clock signal.

13. A system comprising:
a plurality of input circuits, each of the plurality of input circuits using a logic gate to process a pair of input operands and providing either a generate bit or a propagate bit;
a plurality of latch nodes, each of the plurality of latch nodes connected to an output of a respective one of the plurality of input circuits;
clocked latching circuitry coupled to each of the plurality of latch nodes, the clocked latching circuitry latching a respective generate bit or propagate bit to a respective latch node during a first phase of a cycle of a clock signal having two phases; and
logic circuitry that is directly connected to the plurality of latch nodes and that provides a sum of the pair of input operands prior to completion of a second phase of the cycle of the clock signal.

14. The system of claim 13 wherein the logic circuitry further comprises:
carry tree logic having a plurality of inputs, each of the plurality of inputs being directly connected to a respective different latch node, the carry tree logic providing carry terms associated with an addition of the pair of input operands; and
partial sum logic having a plurality of inputs, each of the plurality of inputs being directly connected to a respective different latch node, the partial sum logic providing partial sum terms associated with the addition of the pair of input operands; and
a sum stage connected to the carry tree logic and the partial sum logic, the sum stage providing a sum of the pair of input operands.

15. The system of claim 13 further comprising:
combinational logic circuitry having a plurality of inputs, each of which receives information representing differing operands stored within the system, the combinational logic circuitry providing the first operand and the second operand from the plurality of inputs by directly providing a respective bit of the first operand and the second operand to predetermined inputs of the plurality of input circuits without storing the first operand and the second operand.

16. The system of claim 15 wherein the combinational logic circuitry further comprise logic circuits that form the first operand and the second operand with logical operations using the information that is received.

17. The system of claim 15 wherein the combinational logic circuitry further comprise at least one multiplexer.

18. The system of claim 13 wherein during the first phase of the cycle of the clock signal the pair of input operands are selected within the system, generate bits and propagate bits are formed and stored on the plurality of latch nodes.

19. The system of claim 13 wherein a number of the plurality of input circuits within the system differs from a number of bits used to form the pair of input operands.

20. The system of claim 13 wherein the logic circuitry is a carry look-ahead adder.
